(19) United States
(12) Patent Application Publication
(10) Pub. No.: US 2026/0322000 A1
(43) Pub. Date: Oct. 15, 2026

(54) TERMINATED WIRE AND METHOD FOR MANUFACTURING THE SAME

(71) Applicant: SUMITOMO WIRING SYSTEMS, LTD., Mie (JP)

(72) Inventor: Hiroki YAMANOUCHI, Mie (JP)

(21) Appl. No.: 19/467,580

(22) Filed: Feb. 2, 2026

(30) Foreign Application Priority Data
Feb. 13, 2025 (JP) 2025-021477

(51) Int. Cl. H01R 4/72

(52) U.S. Cl. CPC H01R 4/72

(57) ABSTRACT

A terminated wire includes an electric wire, a terminal, and a shrinkable tube having an adhesive disposed on its inner surface. The terminal has a core wire connection section connected to a core wire, a counterpart connection section extending along an intersecting axis that intersects an axis of the electric wire, and a terminal intermediate section. The terminal intermediate section has: a first bent portion bent from an end portion of the core wire connection section such that a first main surface is an outer surface; an intersecting extension portion extending from the first bent portion along the intersecting axis; a second bent portion bent from a leading end of the intersecting extension portion; and a third bent portion bent from a leading end of the turn-back extension portion.

### CROSS-REFERENCE TO RELATED APPLICATIONS

This application is based on and claims priority from Japanese Patent Application No. 2025-021477, filed on Feb. 13, 2025, with the Japan Patent Office, the disclosure of which is incorporated herein in its entirety by reference.

### TECHNICAL FIELD

The present disclosure relates to a terminated wire and a method for manufacturing the same.

### BACKGROUND

Some conventional terminated wires include an electric wire, a terminal, and a shrinkable tube (e.g., see JP 2023-178648 A). The electric wire includes a core wire and an insulating coating that covers the core wire. The terminal is connected to the core wire exposed from the insulating coating. More specifically, the terminal has a plate shape having first and second main surfaces. The terminal has a core wire connection section that extends along a wire axis and is connected to a core wire, a counterpart connection section that is to be connected to a counterpart member, and a terminal intermediate section that connects the core wire connection section and the counterpart connection section. The shrinkable tube has an adhesive disposed on its inner surface, and covers at portion where the core wire and the terminal are connected. This prevents the portion where the core wire and the terminal are connected from being exposed to water.

### SUMMARY

Some terminals of terminated wires such as that described above include a terminal intermediate section having a bent portion, and thus the extension direction of the core wire connection section intersects the extension direction of the counterpart connection section. In this case, if, for example, the distance from the leading end of the core wire to the bent portion is short, the area covered by the shrinkable tube may become short, resulting in lower water sealing performance. Moreover, for example, if the position of the leading end of the core wire is simply moved away from the bent portion in order to extend the area covered by the shrinkable tube, the position of the core wire connection section moves away from the counterpart connection section, which may make the terminated wire unfittable to a mounting space.

The present disclosure aims to provide a terminated wire and a method for manufacturing a terminated wire that are capable of enhancing water sealing performance while suppressing deterioration of the conditions for a mounting space.

A terminated wire according to the present disclosure includes: an electric wire having a core wire and an insulating coating covering the core wire; a terminal connected to the core wire exposed from the insulating coating; and a shrinkable tube having an adhesive disposed on an inner surface thereof, the shrinkable tube covering a portion where the core wire and the terminal are connected. The terminal has: a core wire connection section to which the core wire is connected, the core wire connection section being formed in a plate shape having a first main surface and a second main surface and extending along an axis of the electric wire; a counterpart connection section that is to be connected to a counterpart member, the counterpart connection section extending along an intersecting axis intersecting the axis of the electric wire; and a terminal intermediate section connecting the core wire connection section and the counterpart connection section. The terminal intermediate section has: a first bent portion bent from an end portion of the core wire connection section such that the first main surface is an outer surface; an intersecting extension portion extending from the first bent portion along the intersecting axis; a second bent portion bent from a leading end of the intersecting extension portion such that the first main surface is an outer surface; a turn-back extension portion extending from the second bent portion along the axis of the electric wire; and a third bent portion bent from a leading end of the turn-back extension portion such that the second main surface is an outer surface, the third bent portion being connected to a base end portion of the counterpart connection section.

The terminated wire and the method for manufacturing a terminated wire according to the present disclosure are capable of enhancing water sealing performance while suppressing deterioration of the conditions for a mounting space.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a partial cross-sectional view of a terminated wire in the process of being manufactured according to one embodiment.

FIG. 2 is a plan view of the terminated wire in the process of being manufactured according to one embodiment.

FIG. 3 is a partial cross-sectional view of the terminated wire according to one embodiment.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of the Present Disclosure

First, modes for implementing the present disclosure are listed and described.

[1] A terminated wire according to the present disclosure includes: an electric wire having a core wire and an insulating coating covering the core wire; a terminal connected to the core wire exposed from the insulating coating; and a shrinkable tube having an adhesive disposed on an inner surface thereof, the shrinkable tube covering a portion where the core wire and the terminal are connected. The terminal has: a core wire connection section to which the core wire is connected, the core wire connection section being formed in a plate shape having a first main surface and a second main surface and extending along an axis of the electric wire; a counterpart connection section that is to be connected to a counterpart member, the counterpart connection section extending along an intersecting axis intersecting the axis of the electric wire; and a terminal intermediate section connecting the core wire connection section and the counterpart connection section. The terminal intermediate section has: a first bent portion bent from an end portion of the core wire connection section such that the first main surface is an outer surface; an intersecting extension portion extending from the first bent portion along the intersecting axis; a second bent portion bent from a leading end of the intersecting extension portion such that the first main surface is an outer surface; a turn-back extension portion extending from the second bent portion along the axis of the electric wire; and a third bent portion bent from a leading end of the turn-back extension portion such that the second main surface is an outer surface, the third bent portion being connected to a base end portion of the counterpart connection section.

According to this configuration, the terminal intermediate section has the first bent portion, the intersecting extension portion, the second bent portion, the turn-back extension portion, and the third bent portion. This makes it possible to increase the distance from the leading end of the core wire to the first bent portion while restraining the position of the core wire connection section from moving farther away from the counterpart connection section. Accordingly, the area covered by the shrinkable tube can be made sufficiently long toward the leading end side of the core wire. This makes it possible to improve water sealing performance while suppressing deterioration of the conditions for a mounting space. That is, if the position of the core wire connection section moves away from the counterpart connection section, there is a concern that the terminated wire will be unfittable to a mounting space. However, such a situation can be avoided, and deterioration of the conditions for the mounting space can thereby be suppressed. In addition, the linear extension distance from the leading end of the core wire to the first bent portion can be increased, thereby making it possible to make the area covered by the shrinkable tube to be sufficiently long toward the leading end side of the core wire. Accordingly, the water sealing performance can be enhanced compared to the case where the area covered by the shrinkable tube is short toward the leading end side of the core wire.

[2] In [1] above, the shrinkable tube may be disposed such that an end portion thereof abuts against the intersecting extension portion.

According to this configuration, the shrinkable tube is disposed such that its end portion abuts against the intersecting extension portion, thereby stabilizing the position of the shrinkable tube. Accordingly, it is possible to stably make the area covered by the shrinkable tube sufficiently long toward the leading end side of the core wire. That is, in a configuration in which the end portion of the shrinkable tube is disposed so as not to abut against the intersecting extension portion, the position of the shrinkable tube is unstable, and there is a concern that the area covered by the shrinkable tube may be short toward the leading end side of the core wire. The above configuration can avoid such a situation. Therefore, the water sealing performance can be stably enhanced.

[3] In [1] or [2] above, the core wire may be connected to the core wire connection section while being disposed on the first main surface of the core wire connection section.

According to this configuration, the core wire is connected to the core wire connection section while being disposed on the first main surface of the core wire connection section. Thus, for example, a large space can be secured on the second main surface side in the core wire connection section. Accordingly, for example, it is possible to prevent a portion including the core wire from overlapping the counterpart connection section layout space to which the counterpart connection section is to be connected.

[4] In any one of [1] to [3] above, the shrinkable tube may have an overlap section extending along the axis of the electric wire at a constant distance from the first main surface and a constant distance from the second main surface.

According to this configuration, the shrinkable tube has the overlap section that extends along the axis of the electric wire at a constant distance from the first main surface and the distance from the second main surface. This makes it possible to increase the water sealing performance along both the first and second main surfaces.

[5] A method for manufacturing a terminated wire according to the present disclosure is a method for manufacturing the terminated wire according to [1] above, and includes: a disposing step of disposing the shrinkable tube before being shrunk having the adhesive disposed on the inner surface thereof such that an end portion of the shrinkable tube abuts against the intersecting extension portion; and a shrinking step of shrinking the shrinkable tube after the disposing step.

According to this method, the shrinkable tube is disposed such that its end portion abuts against the intersecting extension portion. This stabilizes the position of the shrinkable tube, and it is accordingly possible to stably make the area covered by the shrinkable tube sufficiently long toward the leading end side of the core wire. That is, in a configuration in which the end portion of the shrinkable tube is disposed so as not to abut against the intersecting extension portion, the position of the shrinkable tube is unstable, and there is a concern that the area covered by the shrinkable tube may be short toward the leading end side of the core wire. The above configuration can avoid such a situation. Accordingly, the water sealing performance can be stably enhanced with a simple method.

### Details of Embodiments of the Present Disclosure

Specific examples of a terminated wire according to the present disclosure will be described below with reference to the drawings. In the drawings, some configurations may be exaggerated or simplified for convenience of description. Also, the dimensional proportions between parts may differ between the drawings.

The term "tubular shape" as used herein may include not only a shape in which peripheral walls are formed continuously over an entire circumference in a circumferential direction, but also a tubular shape formed by combining multiple parts, and a shape having a cutout or the like in a portion in the circumferential direction, such as a C-shape. The outer shape of the "tubular shape" may include, but is not limited to, a circular shape, an elliptical shape, and a polygonal shape with pointed or round corners. The "tubular shape" may be a shape having a through-hole in a plan view, and may include a shape in which the outer shape is the same as the inner shape around the through-hole, and a shape in which the outer shape differs from the inner shape around the through-hole. The "tubular shape" may include a shape having a predetermined length along an axial direction in which its center axis passing through the center of the through-hole extends, regardless of the length.

The terms "perpendicular" and "constant" as used herein are not limited to being strictly perpendicular or strictly constant, but also include being substantially perpendicular or substantially constant within the scope where the operation and effect of the present embodiment can be achieved. The terms "first, second, third," and the like as used herein are used simply to distinguish between objects, and do not rank objects.

It should be noted that the present invention is not limited to these examples but is defined by the claims, and all modifications equivalent in meaning and scope to the claims are intended to be embraced therein.

### Configuration of Terminated Wire 10

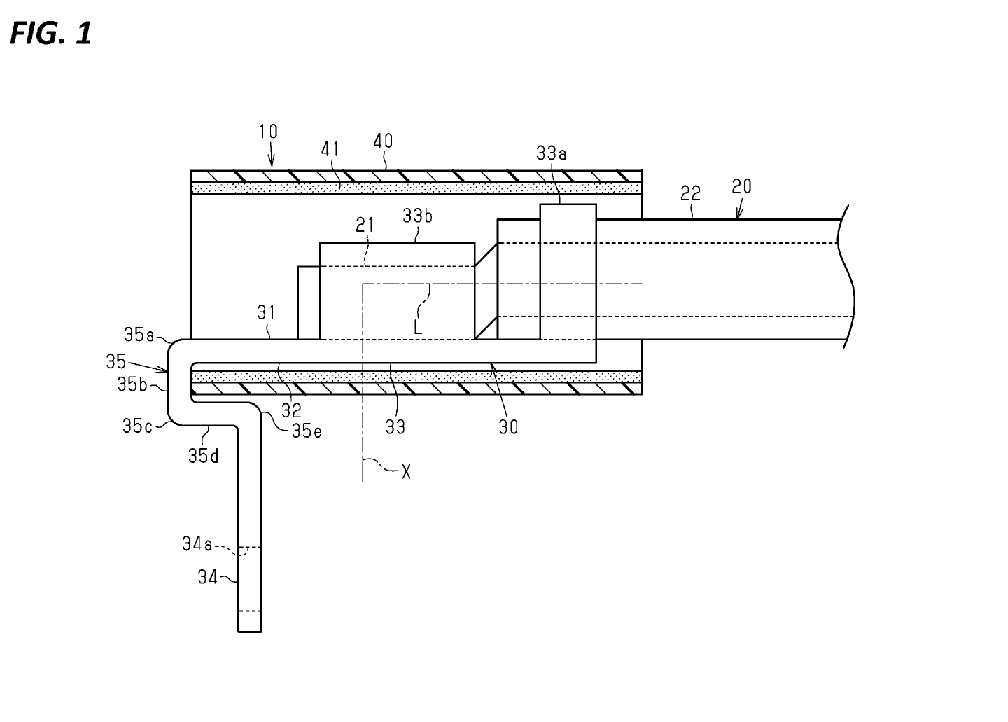

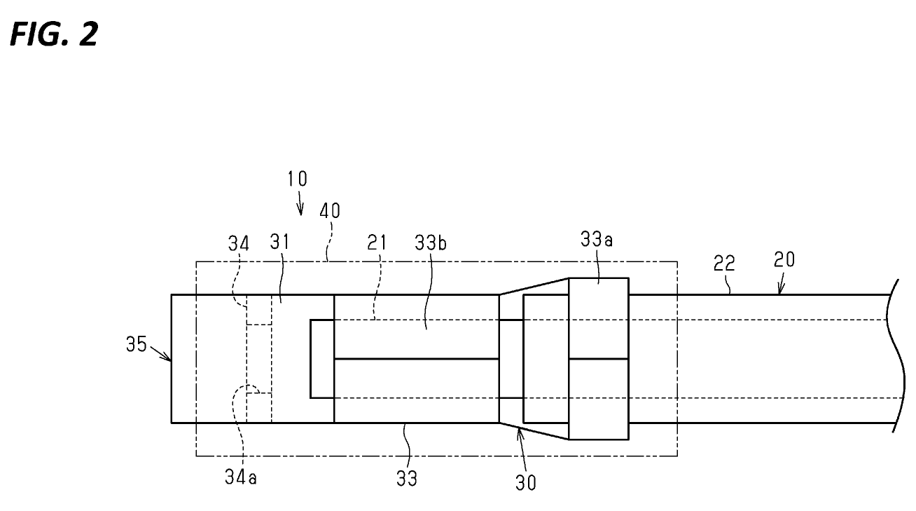

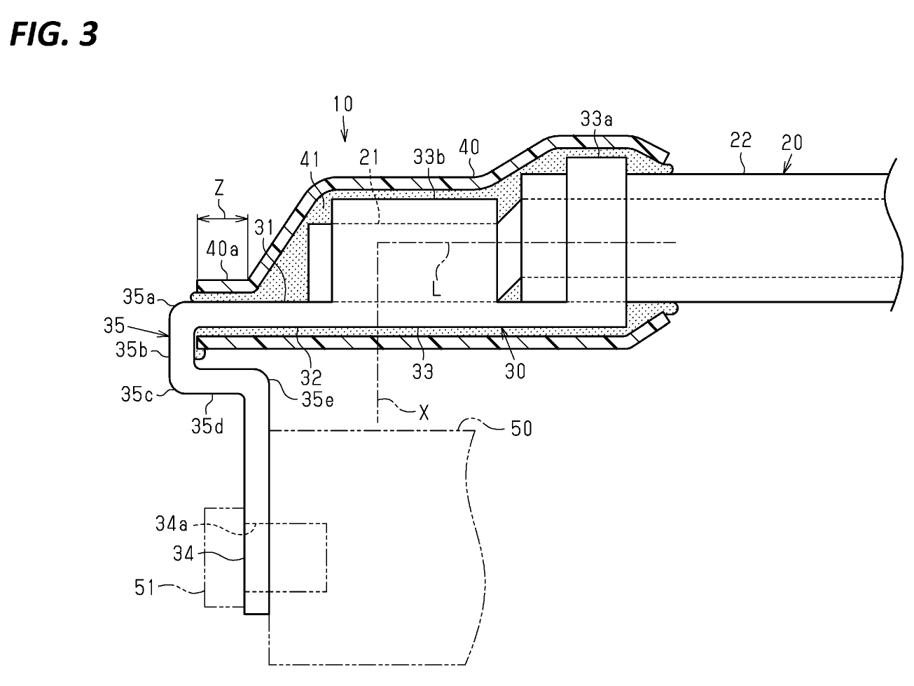

As shown in FIGS. 1-3, a terminated wire 10 includes an electric wire 20, a terminal 30, and a shrinkable tube 40. Note that FIGS. 1 and 2 show the terminated wire 10 in the process of being manufactured, and FIG. 3 shows the completely manufactured terminated wire 10.

### Configuration of Electric Wire 20

The electric wire 20 has a conductive core wire 21 and an insulating coating 22 that covers the core wire 21.

The core wire 21 may be, for example, a stranded wire formed by twisting together a plurality of metal wires, a columnar conductor made of a single columnar metal rod having a solid structure, or the like. The constituent material of the core wire 21 may be, for example, a metal material such as a copper-based material or aluminum-based material.

The insulating coating 22 covers, for example, an outer surface of the core wire 21 over the entire circumference in the circumferential direction. The insulating coating 22 is made of, for example, an insulating material such as a synthetic resin. The constituent material of the insulating coating 22 may be, for example, a synthetic resin containing as a main component a polyolefin-based resin, such as cross-linked polyethylene or cross-linked polypropylene. A longitudinal end of the core wire 21 is exposed from the insulating coating 22.

### Configuration of Terminal 30

The terminal 30 is connected to the core wire 21 exposed from the insulating coating 22. The terminal 30 has a plate shape having a first main surface 31 and a second main surface 32 on the side opposite to the first main surface 31. In other words, the terminal 30 is formed by processing a metal plate material. The constituent material of the terminal 30 may be, for example, a metal material such as a copper-based or aluminum-based material.

The terminal 30 has a core wire connection section 33, a counterpart connection section 34, and a terminal intermediate section 35. The core wire connection section 33 extends along an axis L of the electric wire 20 and is connected to the core wire 21. Note that the axis L of the electric wire 20 here means the axis L of the electric wire 20 at its portion connected to the terminal 30. The counterpart connection section 34 extends along an intersecting axis X that intersects the axis L of the electric wire 20, and is connected to a terminal block 50 (see FIG. 3) serving as a counterpart member, for example. The terminal intermediate section 35 connects the core wire connection section 33 and the counterpart connection section 34.

The core wire connection section 33 in this embodiment has a coating crimp portion 33a and a core wire crimp portion 33b. The coating crimp portion 33a is crimped so as to hold the insulating coating 22 therein while surrounding the insulating coating 22. The core wire crimp portion 33b is crimped so as to hold the core wire 21 therein while surrounding the core wire 21. This electrically and mechanically connects the core wire connection section 33 to the core wire 21.

The core wire 21 in the present embodiment is connected to the core wire connection section 33 while being disposed on the first main surface 31 of the core wire connection section 33. That is, the core wire crimp portion 33b is crimped so as to hold the core wire 21 within the core wire crimp portion 33b while surrounding the core wire 21 on the first main surface 31 of the core wire connection section 33.

The counterpart connection section 34 has a connection hole 34a. As shown in FIG. 3, for example, the counterpart connection section 34 is fastened to the terminal block 50 with a bolt 51 passing through the connection hole 34a, and is electrically connected to the terminal block 50.

As shown in FIGS. 1 and 3, the terminal intermediate section 35 has a first bent portion 35a, an intersecting extension portion 35b, a second bent portion 35c, a turn-back extension portion 35d, and a third bent portion 35e. The first bent portion 35a is bent from an end portion of the core wire connection section 33 such that the first main surface 31 is an outer surface. The intersecting extension portion 35b extends from the first bent portion 35a along the intersecting axis X.

Further, the second bent portion 35c is bent from a leading end of the intersecting extension portion 35b such that the first main surface 31 is an outer surface. The turn-back extension portion 35d extends from the second bent portion 35c along the axis L of the electric wire 20. The third bent portion 35e is bent from a leading end of the turn-back extension portion 35d such that the second main surface 32 is an outer surface, and is connected to a base end portion of the counterpart connection section 34. Note that each of the first bent portion 35a, the second bent portion 35c, and the third bent portion 35e in the present embodiment is bent at a right angle.

### Configuration of Shrinkable Tube 40

The shrinkable tube 40 has a tubular shape, and an adhesive 41 is disposed on its inner surface. The shrinkable tube 40 covers a portion where the core wire 21 and the terminal 30 are connected. Specifically, the shrinkable tube 40 is, for example, a heat-shrinkable tube that shrinks when heated. Examples of the constituent material of the shrinkable tube 40 include a polyolefin resin, a fluorine-based polymer, and a thermoplastic elastomer. Examples of the constituent material of the adhesive 41 include a hot-melt adhesive that melts when heated and hardens when cooled.

Before being heated and shrunk, the shrinkable tube 40 has a cylindrical shape as shown in FIG. 1. Also, before being heated and shrunk, the shrinkable tube 40 has the adhesive 41 disposed on its inner surface with a uniform thickness.

After being heated and shrunk, the shrinkable tube 40 is disposed such that its end portion abuts against the intersecting extension portion 35b, as shown in FIG. 3. Strictly speaking, after being heated and shrunk, the shrinkable tube 40 is disposed such that its end portion abuts against the intersecting extension portion 35b via the adhesive 41. Also, after being heated and shrunk, the shrinkable tube 40 is disposed to cover an end portion of the insulating coating 22, including the coating crimp portion 33a.

Also, after being heated and shrunk, the shrinkable tube 40 has an overlap section 40a that extends along the axis L of the electric wires 20 at a constant distance from the first main surface 31 and a constant distance from the second main surface 32. Note that FIG. 3 illustrates an area Z of the overlap section 40a of the shrinkable tube 40. After the shrinkable tube 40 is heated and shrunk, the adhesive 41 is disposed to fill a gap inside the shrinkable tube 40.

### Method for Manufacturing Terminated Wire 10

Next, a method for manufacturing the terminated wire 10 and the operation thereof will be described.

The method for manufacturing the terminated wire 10 configured as described above includes a disposing step and a shrinking step.

In the disposing step, as shown in FIG. 1, the shrinkable tube 40 before being shrunk with the adhesive 41 disposed on its inner surface is disposed to cover the portion where the core wire 21 and the terminal 30 are connected, and is disposed such that an end portion of the shrinkable tube 40 abuts against the intersecting extension portion 35b.

Next, in the shrinking step, the shrinkable tube 40 is heated and is thereby shrunk from the state shown in FIG. 1 to the state shown in FIG. 3. At this time, the adhesive 41 temporarily melts and fills the gap inside the shrinkable tube 40. The manufacture of the terminated wire 10 is thus completed.

With the thus-configured terminated wire 10, the shrinkable tube 40 and the adhesive 41 prevent the core wire connection section 33 and the core wire 21 from being exposed to water. Accordingly, for example, corrosion is suppressed in the area where the core wire connection section 33 and the core wire 21 are connected.

### Effects of the Present Embodiment

Next, effects of the above embodiment will be described.

(1) The terminal intermediate section 35 has the first bent portion 35a, the intersecting extension portion 35b, the second bent portion 35c, the turn-back extension portion 35d, and the third bent portion 35e. Accordingly, the distance from the leading end of the core wire 21 to the first bent portion 35a can be increased while restraining the core wire connection section 33 from moving away from the counterpart connection section 34 (i.e., rightward in FIG. 3). Accordingly, the area covered by the shrinkable tube 40 can be made sufficiently long toward the leading end side of the core wire 21. This makes it possible to improve water sealing performance while suppressing deterioration of the conditions for a mounting space. That is, if the position of the core wire connection section 33 moves away from the counterpart connection section 34 (i.e., rightward in FIG. 3), there is a concern that the terminated wire will be unfittable to a mounting space. However, such a situation can be avoided, and deterioration of the conditions for the mounting space can thereby be suppressed. In addition, since the linear extension distance from the leading end of the core wire 21 to the first bent portion 35a can be made long, the area covered by the shrinkable tube 40 can be made sufficiently long on the leading end side of the core wire 21. Accordingly, the water sealing performance can be increased compared to the case where the area covered by the shrinkable tube 40 is short toward the leading end side of the core wire 21.

Also, the adhesive 41 is restrained from reaching the counterpart connection section 34 by the terminal intermediate section 35 that has the first bent portion 35a, the intersecting extension portion 35b, the second bent portion 35c, the turn-back extension portion 35d, and the third bent portion 35e. That is, the adhesive 41 in a melted state may be about to flow toward the counterpart connection section 34, but the terminal intermediate section 35 having a complicated shape restrains this adhesive 41 from reaching the counterpart connection section 34. This restrains the adhesive 41 from inhibiting the connection between the counterpart connection section 34 and the terminal block 50, for example.

(2) The shrinkable tube 40 is disposed such that its end portion abuts against the intersecting extension portion 35b. Thus, the position of the shrinkable tube 40 is stabilized, and it is accordingly possible to stably make the area covered by the shrinkable tube 40 sufficiently long toward the leading end side of the core wire 21. That is, in a configuration in which the end portion of the shrinkable tube 40 is disposed so as not to abut against the intersecting extension portion 35b, the position of the shrinkable tube 40 is unstable, and thus there is a concern that the area covered by the shrinkable tube 40 becomes short toward the leading end side of the core wire 21. However, such a situation can be avoided. Therefore, the water sealing performance can be stably enhanced.

(3) The core wire 21 is connected to the core wire connection section 33 while being disposed on the first main surface 31 of the core wire connection section 33. Thus, for example, a large space can be secured on the second main surface 32 side in the core wire connection section 33. Accordingly, for example, it is possible to prevent a portion including the core wire 21 from overlapping a layout space for the terminal block 50, which is a counterpart member to which the counterpart connection section 34 is to be connected.

(4) The shrinkable tube 40 has the overlap section 40a that extends along the axis L of the electric wire 20 at a constant distance from the first main surface 31 and a constant distance from the second main surface 32. This makes it possible to increase the water sealing performance along both the first main surface 31 and the second main surface 32.

(5) In the disposing step of the method for manufacturing the terminated wire 10, the shrinkable tube 40 is disposed such that its end portion abuts against the intersecting extension portion 35b. Thus, the position of the shrinkable tube 40 is stabilized, and it is accordingly possible to stably make the area covered by the shrinkable tube 40 sufficiently long toward the leading end side of the core wire 21. That is, in a configuration in which the end portion of the shrinkable tube 40 is disposed so as not to abut against the intersecting extension portion 35b, the position of the shrinkable tube 40 is unstable, and thus there is a concern that the area covered by the shrinkable tube 40 becomes short toward the leading end side of the core wire 21. However, such a situation can be avoided. Accordingly, the water sealing performance can be stably enhanced with a simple method.

### Modifications

The above embodiment can be modified for implementation as follows. The above embodiment and the following modifications can be implemented in combination with each other as long as no technical contradiction arises.
In the above embodiment, the shrinkable tube 40 is disposed such that its end portion abuts against the intersecting extension portion 35b. However, the invention is not limited to this. For example, the end portion of the shrinkable tube 40 may be separated from the intersecting extension portion 35b. That is, a configuration may also be used in which a gap is disposed between the end portion of the shrinkable tube 40 and the intersecting extension portion 35b.
In the above embodiment, the core wire 21 is connected to the core wire connection section 33 while being disposed on the first main surface 31 of the core wire connection section 33. However, the invention is not limited to this. For example, the core wire 21 may alternatively be connected to the core wire connection section 33 while being disposed on the second main surface 32 (i.e., lower side of second main surface 32 in FIG. 3) of the core wire connection section 33. That is, the core wire 21 may be connected to the core wire connection section 33 while being disposed on the side of the core wire connection section 33 where the first bent portion 35a is bent.
In the above embodiment, the shrinkable tube 40 has the overlap section 40a that extends along the axis L of the electric wires 20 at a constant distance from the first main surface 31 and a constant distance from the second main surface 32. However, the invention is not limited to this, and the overlap section 40a may be omitted
In the disposing step of the method for manufacturing the terminated wire 10 in the above embodiment, the end portion of the shrinkable tube 40 is disposed to abut against the intersecting extension portion 35b. However, the present invention is not limited to this, and the end portion of the shrinkable tube 40 may alternatively be disposed so as not to abut against the intersecting extension portion 35b.
In the above embodiment, the core wire connection section 33 has the coating crimp portion 33a and the core wire crimp portion 33b. However, this configuration may be changed as long as the core wire 21 is connected to the core wire connection section 33.
In the description and drawings of the above embodiment, the terminal intermediate section 35 has the intersecting extension portion 35b and the turn-back extension portion 35d that extend linearly when viewed from the side (see FIG. 3). However, the present invention is not limited to this. For example, the core wire connection section 33, the first bent portion 35a, the intersecting extension portion 35b, the second bent portion 35c, and the turn-back extension portion 35d may alternatively be formed in a U-shape that curves and turns back, and the intersecting extension portion 35b need not extend linearly along the intersecting axis X.
The method for manufacturing the terminated wire 10 in the above embodiment may be changed to another manufacturing method as long as the same terminated wire 10 can be manufactured. For example, in the disposing step of the method for manufacturing the terminated wire 10, the shrinkable tube 40 is disposed such that its end portion abuts against the intersecting extension portion 35b. However, a configuration may alternatively be used in which the end portion of the shrinkable tube 40 is disposed so as not to abut against the intersecting extension portion 35b.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A terminated wire comprising:
an electric wire having a core wire and an insulating coating covering the core wire;
a terminal connected to the core wire exposed from the insulating coating; and
a shrinkable tube having an adhesive disposed on an inner surface thereof, the shrinkable tube covering a portion where the core wire and the terminal are connected,
wherein the terminal has:
a core wire connection section to which the core wire is connected, the core wire connection section being formed in a plate shape having a first main surface and a second main surface and extending along an axis of the electric wire;
a counterpart connection section that is to be connected to a counterpart member, the counterpart connection section extending along an intersecting axis intersecting the axis of the electric wire; and
a terminal intermediate section connecting the core wire connection section and the counterpart connection section, and
the terminal intermediate section has:
a first bent portion bent from an end portion of the core wire connection section such that the first main surface is an outer surface;
an intersecting extension portion extending from the first bent portion along the intersecting axis;
a second bent portion bent from a leading end of the intersecting extension portion such that the first main surface is an outer surface;
a turn-back extension portion extending from the second bent portion along the axis of the electric wire; and
a third bent portion bent from a leading end of the turn-back extension portion such that the second main surface is an outer surface, the third bent portion being connected to a base end portion of the counterpart connection section.

2. The terminated wire according to claim 1,
wherein the shrinkable tube is disposed such that an end portion thereof abuts against the intersecting extension portion.

3. The terminated wire according to claim 1,
wherein the core wire is connected to the core wire connection section while being disposed on the first main surface of the core wire connection section.

4. The terminated wire according to claim 1,
wherein the shrinkable tube has an overlap section extending along the axis of the electric wire at a constant distance from the first main surface and a constant distance from the second main surface.

5. A method for manufacturing the terminated wire according to claim 1, the method comprising:
a disposing step of disposing the shrinkable tube before being shrunk having the adhesive disposed on the inner surface thereof such that an end portion of the shrinkable tube abuts against the intersecting extension portion; and
a shrinking step of shrinking the shrinkable tube after the disposing step.
